(19) United States
(12) Patent Application Publication
(10) Pub. No.: US 2003/0110232 A1
(43) Pub. Date: Jun. 12, 2003

(54) Distributing messages between local queues representative of a common shared queue

(75) Inventors: Shawfu Chen, New Milford, CT (US); Robert O. Dryfoos, Hopewell Junction, NY (US); Allan Feldman, Poughkeepsie, NY (US); David Y. Hu, Poughkeepsie, NY (US); Masashi E. Miyake, Poughkeepsie, NY (US); Wei-Yi Xiao, Poughkeepsie, NY (US)

Correspondence Address: Blanche E. Schiller, Esq., Heslin Rothenberg Farley & Mesiti P.C., 5 Columbia Circle, Albany, NY, 12203, US

(73) Assignee: International Business Machines Corporation, Armonk, NY (US)

(21) Appl. No.: 10/014,089

(22) Filed: Dec. 11, 2001

(51) Int. Cl. G06F 15/167

(52) U.S. Cl. 709/212; 709/214

(57) ABSTRACT

A common shared queue is provided, which includes a plurality of local queues. Each local queue is resident on a storage medium coupled to a processor. The local queues are monitored, and when it is determined that a particular local queue is being inadequately serviced, then one or more messages are moved from that local queue to one or more other local queues of the common shared queue.

### TECHNICAL FIELD

This invention relates, in general, to configuring and managing common shared queues, and in particular, to representing a common shared queue as a plurality of local queues and to distributing messages between the local queues to balance workloads of processors servicing the local queues.

### BACKGROUND OF THE INVENTION

One technology that supports messaging and queueing is referred to as MQSeries, which is offered by International Business Machines Corporation. With MQSeries, users can dramatically reduce application development time by using MQSeries API functions. Since MQSeries supports many platforms, MQSeries applications can be ported easily from one platform to another.

In a loosely coupled environment, an application, such as an MQ application, runs on a plurality of processors to improve system throughput. Persistent messages of the MQ application are stored on a common shared DASD queue, which is a single physical queue shared among the processors. To control the sharing of the queue, the processors access a table that contains pointers to messages within the queue. Since multiple processors access this table to process messages of the queue, the table is a bottleneck to system throughput. In particular, locks on the table used to prevent corruption of the table cause bottlenecks for the processors; thus, slowing down the performance of the multiple processors to a single processor performance.

Based on the foregoing, a need exists for a facility that significantly reduces the bottleneck caused by the common shared queue. In particular, a need exists for a different design of the common shared queue. A further need exists for a capability that manages the workload of the redesigned common shared queue.

### SUMMARY OF THE INVENTION

The shortcomings of the prior art are overcome and additional advantages are provided through the provision of a method of managing common shared queues of a communications environment. The method includes, for instance, providing a plurality of shared queues representative of a common shared queue, the plurality of shared queues being coupled to a plurality of processors; and moving one or more messages from one shared queue of the plurality of shared queues to one or more other shared queues of the plurality of shared queues, in response to a detected condition.

In a further aspect of the present invention, a method of managing common shared queues of a communications environment is provided. The method includes, for instance, providing a plurality of shared queues representative of a common shared queue, each shared queue of the plurality of shared queues being local to a processor of the communications environment; monitoring, by at least one processor of the communications environment, queue depth of one or more shared queues of the plurality of shared queues; determining, via the monitoring, that the queue depth of a shared queue of the one or more shared queues is at a defined level; and moving one or more messages from the shared queue to one or more other shared queues of the plurality of shared queues, in response to the determining.

Another aspect of the present invention includes a method of providing a common shared queue. The method includes, for instance, providing a plurality of shared queues representative of a common shared queue, the plurality of shared queues being coupled to a plurality of processors; and accessing, by a distributed application executing across the plurality of processors, the plurality of shared queues to process data used by the distributed application.

System and computer program products corresponding to the above-summarized methods are also described and claimed herein.

Advantageously, a common shared queue is configured as a plurality of local shared queues, each accessible to a processor. Moreover, advantageously, workloads of the plurality of local shared queues are balanced to enhance system performance.

Additional features and advantages are realized through the techniques of the present invention. Other embodiments and aspects of the invention are described in detail herein and are considered a part of the claimed invention.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 depicts one embodiment of a prior communications environment having a common shared queue, which is configured as one physical queue and accessed by a plurality of processors;

FIG. 2 depicts one embodiment of a communications environment in which the common shared queue is represented by a plurality of local queues, in accordance with an aspect of the present invention;

FIG. 3 depicts one embodiment of the logic associated with moving messages from one local queue to one or more other local queues of the common shared queue, in accordance with an aspect of the present invention;

FIGS. 4a-4b depict one embodiment of the logic associated with a processor controlling message distribution between the local queues, in accordance with an aspect of the present invention; and

FIGS. 4c and 4d depict one embodiment of the logic associated with completing the task of message distribution, in accordance with an aspect of the present invention.

### BEST MODE FOR CARRYING OUT THE INVENTION

Common shared queues are used to store data, such as messages, employed by distributed applications executing on a plurality of processors of a communications environment. Typically, common shared queues have certain attributes, such as, for example, they are accessible from multiple processors; application transactions using a common shared queue are normally short (e.g., a banking transaction or an airline reservation, but not a file transfer); when a transaction is rolled back, it is possible that the same message can be retrieved by other processors; and it is unpredictable as to which message in the queue will be serviced by which processor. The use of a common shared queue by a distributed application enables the application to be seen as a single image from outside the communications environment. Previously, each common shared queue included one physical queue stored on one or more direct access storage devices (DASD).

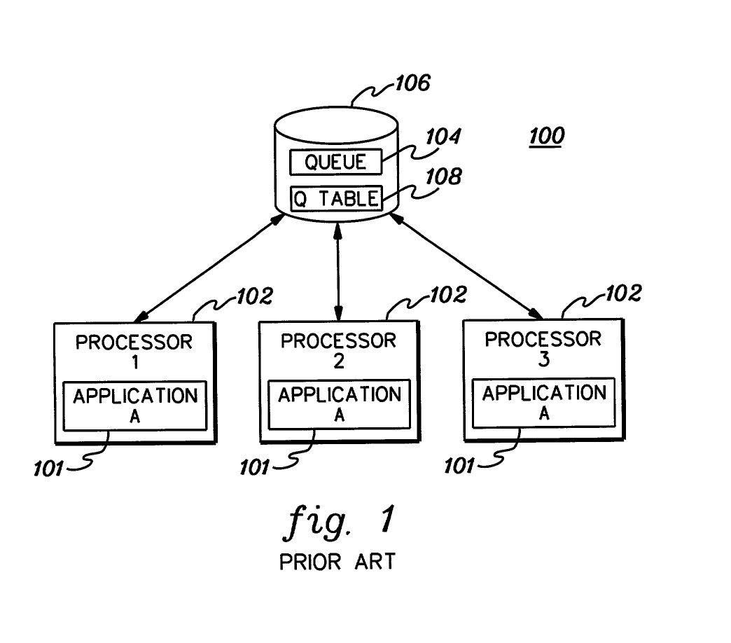

One example of a communications environment using such a common shared queue is described with reference to FIG. 1. As depicted in FIG. 1, a loosely coupled environment 100 includes a distributed application 101 executing on a plurality of processors 102, in order to improve performance of the application. The application accesses a common shared queue 104, which includes one physical queue resident on a direct access storage device (DASD) 106. The shared queue is used, in this example, for storing persistent messages used by the application. In order to access messages in the queue, each processor accesses a queue table 108, which includes pointers to the messages in the queue. Corruption of the table is prevented by using locks. The use of these locks, however, causes a bottleneck of the operation and slows down the performance of the application to a single processor performance.

One or more aspects of the present invention address this bottleneck, as well as provide workload distribution among the processors. Specifically, in accordance with an aspect of the present invention, the common shared queue is configured as a plurality of physical local queues, in which each processor accesses its own local queue rather than a common queue accessed by multiple processors. Messages that arrive at a processor are placed on the local queue of that processor (i.e., the queue assigned to that processor). Although each processor has its own local queue, the queue is still considered a shared queue, since the messages on each local queue may be shared among the processors. In this example, each queue of a particular common shared queue has basically the same name, but each queue may have different contents. That is, one queue is not a copy of another queue. For example, the common shared queue may be a reservation queue. Thus, there are a plurality of local reservation queues, each including one or more messages pertaining to a reservation application.

Messages in a local shared queue are processed by the local application, unless it is determined, in accordance with an aspect of the present invention, that the messages are to be redistributed from the local queue of one processor to one or more other local queues of one or more other processors, as described below.

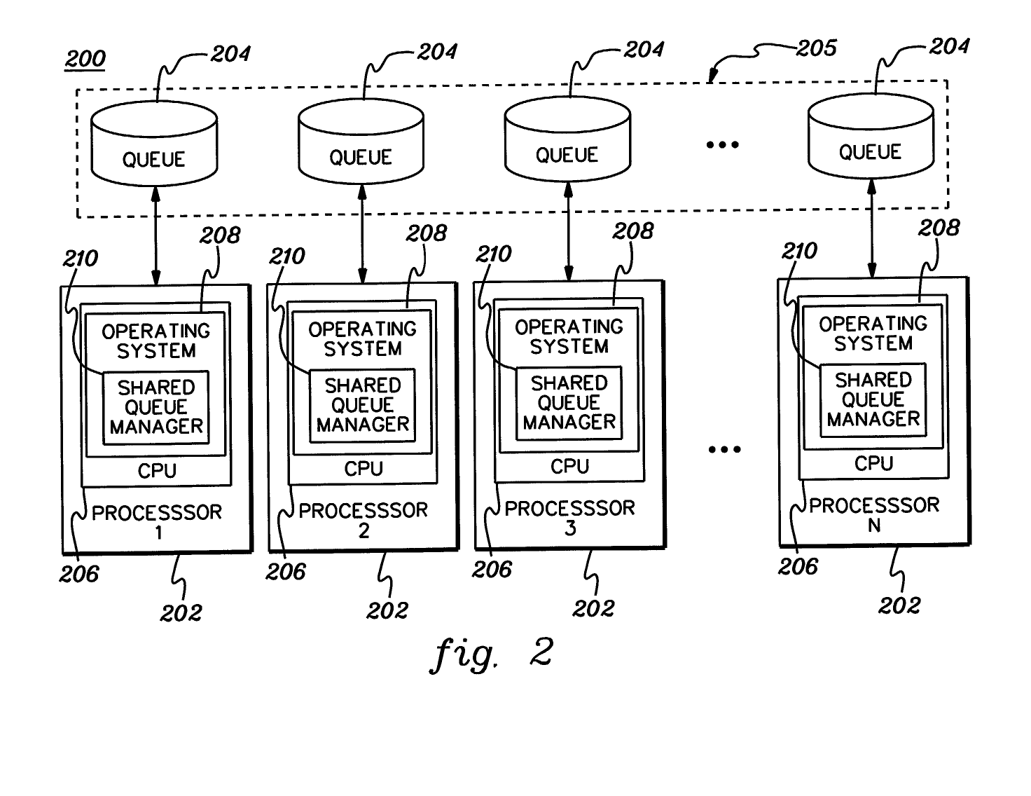

One embodiment of a communications environment incorporating and using common shared queues defined in accordance with an aspect of the present invention is described with reference to FIG. 2. A communications environment 200 includes, for instance, a plurality of processors 202 loosely coupled to one another via, for instance, one or more intersystem channels. Each processor (or a subset thereof) is coupled to at least one local queue 204. A plurality of the local queues represent a common shared queue 205, in which messages of the common shared queue are shared among the plurality of local queues. In this example, the local queues are resident on one or more direct access storage devices (DASD) accessible to each of the processors. In other examples, however, the queues may be located on other types of storage media.

Although one common shared queue comprising a plurality of local queues is depicted in FIG. 2, the communications environment may include a plurality of common shared queues, each including one or more local queues.

Each processor 202 includes at least one central processing unit (CPU) 206, which executes at least one operating system 208, such as the TPF operating system, offered by International Business Machines Corporation, Armonk, N.Y. Operating system 208 includes, for instance, a shared queue manager 210 distributed across the processors, which is used, in accordance with an aspect of the present invention, to balance the workload of the local queues representing the common shared queue. In one example, the shared queue manager may be a part of an MQManager, which is a component of MQSeries, offered by International Business Machines Corporation, Armonk, N.Y. However, this is only one example. The shared queue manager need not be a part of MQManager or any other manager.

Further, although MQSeries is referred to herein, the various aspects of the present invention are not limited to MQSeries. One or more aspects of the present invention are applicable to other applications that use or may want to use common shared queues.

As described above, in order to reduce the bottleneck constraints of the previous design of common shared queues, the common shared queues of an aspect of the present invention are reconfigured to include a plurality of local physical queues. Each processor accesses its own physical queue, which is considered a part of a common shared queue (i.e., logically). This enables applications executing on the processors that access those queues to run more efficiently.

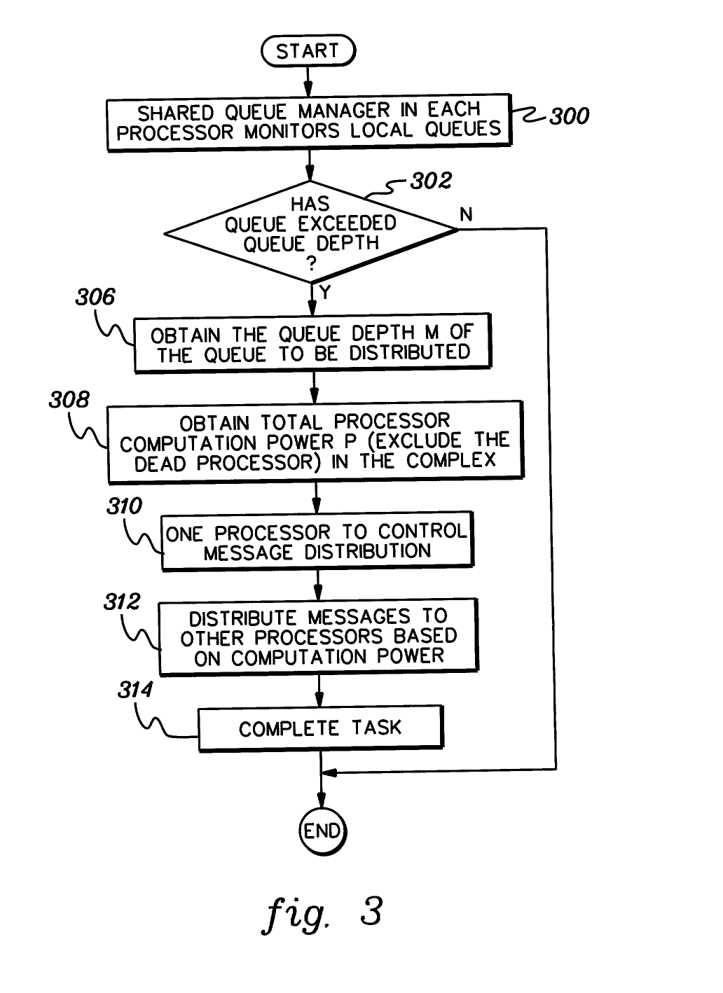

In another aspect of the present invention, workload distribution among the local queues of the various processors is provided. For example, messages in the local queue are processed by a local application, until it is determined that the local queue is not being adequately serviced (e.g., the local application slows down due to system resources, the local application becomes unavailable due to application error or other conditions exist). When the queue reaches a defined level (e.g., a preset high watermark) indicating that it is not being adequately serviced, then at least one of the shared queue managers redistributes one or more messages of the inadequately serviced queue to one or more other queues of the common shared queue. One embodiment of a technique for balancing workload among the different processors is described with reference to FIG. 3.

At periodic intervals (e.g., every 2-5 seconds), the shared queue manager in each processor monitors the depth of each of the local queues representing a common shared queue, STEP 300. During this monitoring, each shared queue manager determines whether the depth of any of the queues has exceeded a defined queue depth, INQUIRY 302. If none of the defined queue depths has been exceeded, then processing is complete for this periodic interval. However, if a defined queue depth has been exceeded, then each processor making this determination obtains the queue depth (M) of the queue having messages to be distributed, STEP 306. (In one example, the procedure described herein is performed for each queue exceeding the defined queue depth.) Additionally, each processor making the determination obtains the total processor computation power (P) of the complex, STEP 308. This is accomplished by adding the relevant powers, which are located in shared memory. In one example, the total processor power that is obtained excludes the processor from which messages are being distributed. (In another example, it may exclude each processor having an inadequately serviced queue.)

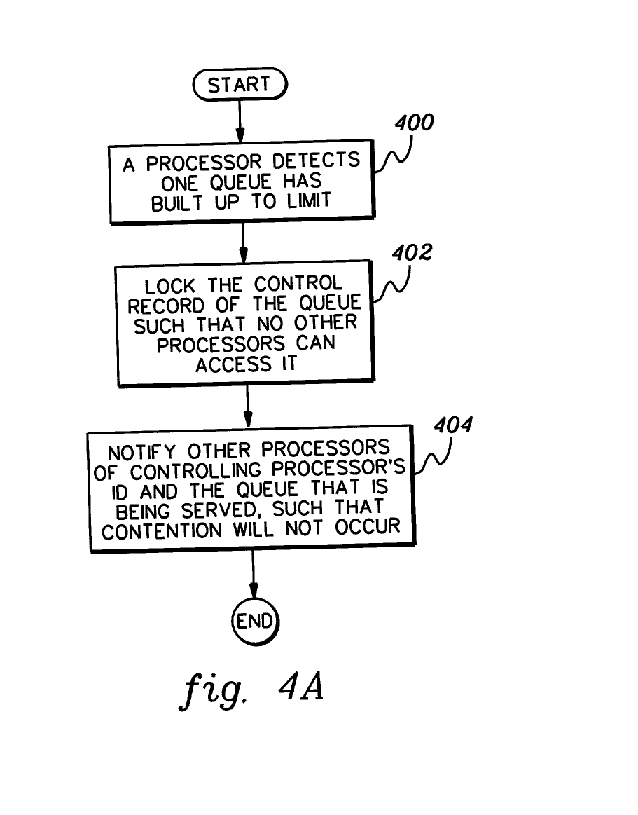

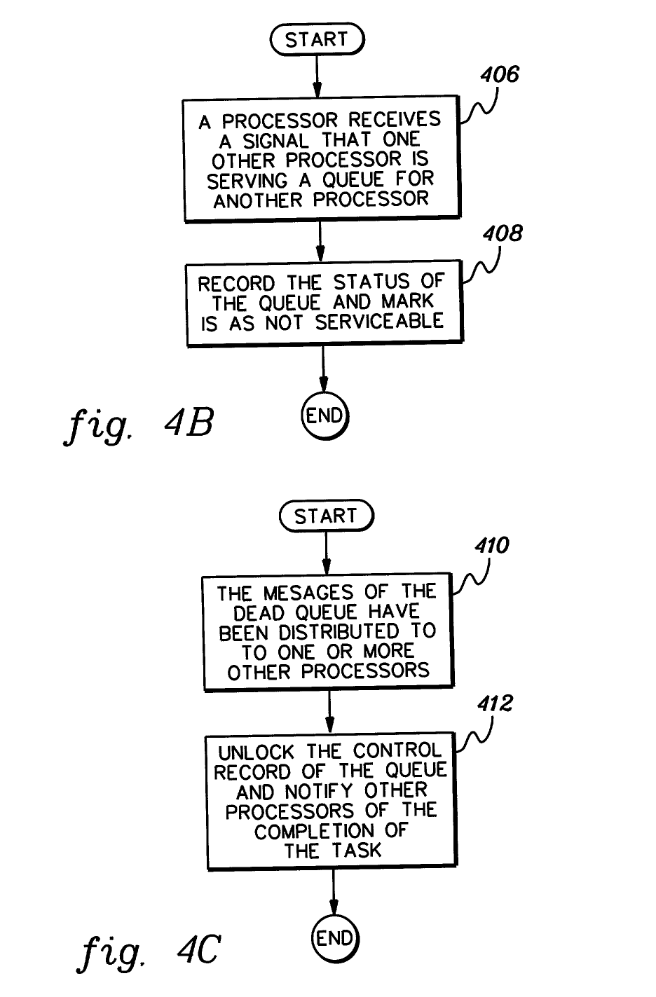

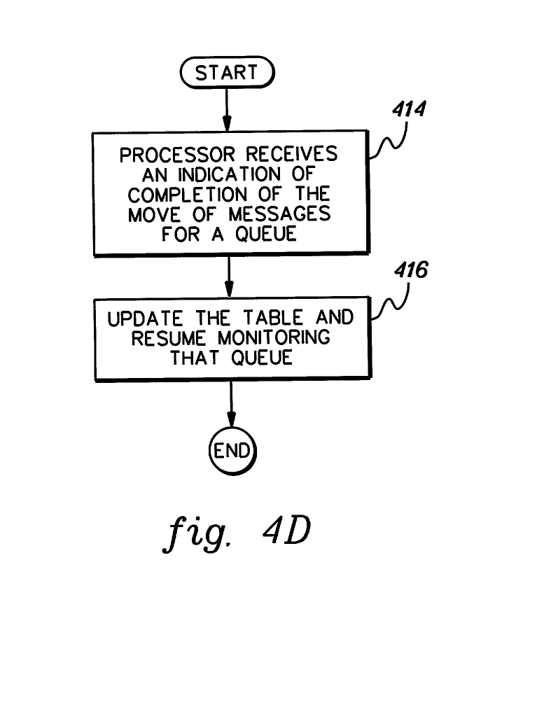

At this point, one of the processors that has made the determination that messages are to be redistributed takes control of the redistribution, STEP 310. In one example, the processor to take control is the first processor to lock a control record of the local queue preventing other processors from accessing it. This is further described with reference to FIG. 4a.

Referring to FIG. 4a, when a processor detects that a queue is not being adequately serviced, STEP 400, the processor locks a control record associated with the queue, so that no other processors can access the queue, STEP 402. Further, the controlling processor notifies one or more other processors of the environment of the action being taken, in order to prevent contention, STEP 404. In one example, this notification includes providing the one or more other processors with the id of the controlling processor and the id (e.g., name) of the queue being serviced.

When a processor receives a signal that another processor is servicing a queue, STEP 406 (FIG. 4b), the processor receiving the notification records the status of the queue and marks it as not serviceable in, for instance, a local copy of a queue table, STEP 408.

Returning to FIG. 3, thereafter, the messages of the identified queue are distributed to one or more other processors, STEP 312. In one example, the messages are distributed based on processor speed. For instance, the messages are distributed based on a ratio of local processor power to the total processor power (P) determined above. As one example, if the total processor power of the processors sharing the common queue is 100 and the local processor power of a processor that may receive messages is 10, then that processor is to receive 1/10 of the messages to be moved. However, prior to moving the messages to a particular queue, a further determination is made as to whether the moving of the messages to that queue would cause that queue to exceed a defined limit (e.g., a preset queue depth minus one). If so, then messages are moved to that queue until the number of messages in the queue is equal to the preset queue depth minus one. The additional messages are distributed elsewhere. (It should be noted that each queue may have the same or different highwater mark.)

Subsequent to distributing the messages, the workload balancing task is completed, STEP 314. One embodiment of the logic associated with completing the task is described with reference to FIGS. 4c-4d.

Referring to FIG. 4c, when the messages of the inadequately serviced queue have been distributed to one or more other processors, STEP 410, the control record of the queue is unlocked and one or more other processors (e.g., the one or more other processors coupled to the common shared queue) are notified of completion of the workload balancing task, STEP 412.

When a processor receives an indication of completion of the move of messages for a queue, STEP 414 (FIG. 4d), then the local copy of the queue table is updated to reflect the same and monitoring of that queue is resumed, STEP 416.

Described in detail above is a common shared queue, which is represented by a plurality of local queues. The use of the plurality of local queues advantageously enables processors to process applications without competing with each other for the shared queue. This improves performance of the application and overall system performance. Further, with the automation of queue message distribution, in response to a queue not being adequately serviced, the total queue performance is enhanced.

In the above embodiment, each queue manager associated with the common shared queue performs the monitoring and various other tasks. However, in other embodiments, a subset (e.g., one or more) of the managers performs the monitoring and various other tasks. Further, in the above embodiment, a particular processor takes control subsequent to performing various tasks. In other embodiments, the processor can take control earlier in the process. Other variations are also possible.

The communications environment described above is only one example. For instance, although the operating system is described as TPF, this is only one example. Various other operating systems can be used. Further, the operating systems in the different computing environments can be heterogeneous. One or more aspects of the invention work with different platforms. Additionally, the invention is usable by other types of environments.

As described above, in accordance with an aspect of the present invention, common shared queues are configured and managed. A common shared queue is configured as a plurality of queues (i.e., queues that include messages that may be shared among processors), and when it is determined that at least one of the queues has reached a defined level, messages are moved from the at least one queue to one or more other queues of the common shared queue.

The present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. All of these variations are considered a part of the claimed invention.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

what is claimed is:

1. A method of managing common shared queues of a communications environment, said method comprising:
providing a plurality of shared queues representative of a common shared queue, said plurality of shared queues being coupled to a plurality of processors; and
moving one or more messages from one shared queue of the plurality of shared queues to one or more other shared queues of the plurality of shared queues, in response to a detected condition.

2. The method of claim 1, wherein said plurality of shared queues reside on one or more external storage media coupled to the plurality of processors.

3. The method of claim 2, wherein said one or more external storage media comprise one or more direct access storage devices.

4. The method of claim 1, wherein each shared queue of said plurality of shared queues is local to a processor of said plurality of processors.

5. The method of claim 1, wherein said detected condition comprises a depth of said one shared queue being at a defined level.

6. The method of claim 1, wherein said moving comprises removing the one or more messages from the one shared queue and placing the one or more messages on the one or more other shared queues based on one or more distribution factors.

7. The method of claim 6, wherein the one or more distribution factors comprise processor power of at least one processor of the plurality of processors.

8. The method of claim 6, wherein the placing comprises determining a number of messages of the one or more messages to be placed on a selected shared queue of the one or more other shared queues.

9. The method of claim 8, wherein the one or more distribution factors comprise local processor power of the processor associated with the selected shared queue and total processor power of at least one processor of the plurality of processors, and wherein the determining comprises using a ratio of local processor power to total processor power in determining the number of messages to be placed on the selected shared queue.

10. The method of claim 9, wherein the determining further comprises adjusting the number of messages to be placed on the selected shared queue, if the number of messages is determined to be unsatisfactory for the selected shared queue.

11. The method of claim 10, wherein the number of messages is determined to be unsatisfactory, when a depth of the selected shared queue would be at a selected level should that number of messages be added.

12. The method of claim 1, wherein said moving is managed by at least one processor of the plurality of processors.

13. The method of claim 12, wherein said at least one processor provides an indication to at least one other processor of the plurality of processors that it is managing a move associated with the one shared queue.

14. A method of managing common shared queues of a communications environment, said method comprising:
providing a plurality of shared queues representative of a common shared queue, each shared queue of said plurality of shared queues being local to a processor of the communications environment;
monitoring, by at least one processor of the communications environment, queue depth of one or more shared queues of the plurality of shared queues;
determining, via the monitoring, that the queue depth of a shared queue of the one or more shared queues is at a defined level; and
moving one or more messages from the shared queue to one or more other shared queues of the plurality of shared queues, in response to the determining.

15. The method of claim 14, wherein said plurality of shared queues are resident on one or more direct access storage devices accessible to the processors coupled to the plurality of shared queues.

16. The method of claim 14, wherein said moving comprises determining, for each other shared queue of the one or more other shared queues, a number of messages of the one or more messages to be distributed to that other shared queue.

17. The method of claim 16, wherein the determining is based at least in part on processor power of the processor local to the other shared queue.

18. The method of claim 16, wherein the determining comprises adjusting the number, should that number of messages be undesirable for that other shared queue.

19. A method of providing a common shared queue, said method comprising:
providing a plurality of shared queues representative of a common shared queue, said plurality of shared queues being coupled to a plurality of processors; and
accessing, by a distributed application executing across the plurality of processors, the plurality of shared queues to process data used by the distributed application.

20. A system of managing common shared queues of a communications environment, said system comprising:
a plurality of shared queues representative of a common shared queue, said plurality of shared queues being coupled to a plurality of processors; and
means for moving one or more messages from one shared queue of the plurality of shared queues to one or more other shared queues of the plurality of shared queues, in response to a detected condition.

21. The system of claim 20, wherein said plurality of shared queues reside on one or more external storage media coupled to the plurality of processors.

22. The system of claim 21, wherein said one or more external storage media comprise one or more direct access storage devices.

23. The system of claim 20, wherein each shared queue of said plurality of shared queues is local to a processor of said plurality of processors.

24. The system of claim 20, wherein said detected condition comprises a depth of said one shared queue being at a defined level.

25. The system of claim 20, wherein said means for moving comprises means for removing the one or more messages from the one shared queue, and means for placing the one or more messages on the one or more other shared queues based on one or more distribution factors.

26. The system of claim 25, wherein the one or more distribution factors comprise processor power of at least one processor of the plurality of processors.

27. The system of claim 25, wherein the means for placing comprises means for determining a number of messages of the one or more messages to be placed on a selected shared queue of the one or more other shared queues.

28. The system of claim 27, wherein the one or more distribution factors comprise local processor power of the processor associated with the selected shared queue and total processor power of at least one processor of the plurality of processors, and wherein the means for determining comprises means for using a ratio of local processor power to total processor power in determining the number of messages to be placed on the selected shared queue.

29. The system of claim 28, wherein the means for determining further comprises means for adjusting the number of messages to be placed on the selected shared queue, if the number of messages is determined to be unsatisfactory for the selected shared queue.

30. The system of claim 29, wherein the number of messages is determined to be unsatisfactory, when a depth of the selected shared queue would be at a selected level should that number of messages be added.

31. The system of claim 20, wherein the moving is managed by at least one processor of the plurality of processors.

32. The system of claim 31, wherein said at least one processor provides an indication to at least one other processor of the plurality of processors that it is managing a move associated with the one shared queue.

33. A system of managing common shared queues of a communications environment, said system comprising:
a plurality of shared queues representative of a common shared queue, each shared queue of said plurality of shared queues being local to a processor of the communications environment;
means for monitoring, by at least one processor of the communications environment, queue depth of one or more shared queues of the plurality of shared queues;
means for determining that the queue depth of a shared queue of the one or more shared queues is at a defined level; and
means for moving one or more messages from the shared queue to one or more other shared queues of the plurality of shared queues, in response to the determining.

34. The system of claim 33, wherein said plurality of shared queues are resident on one or more direct access storage devices accessible to the processors coupled to the plurality of shared queues.

35. The system of claim 33, wherein said means for moving comprises means for determining, for each other shared queue of the one or more other shared queues, a number of messages of the one or more messages to be distributed to that other shared queue.

36. The system of claim 35, wherein the determining is based at least in part on processor power of the processor local to the other shared queue.

37. The system of claim 35, wherein the means for determining comprises means for adjusting the number, should that number of messages be undesirable for that other shared queue.

38. A system of providing a common shared queue, said system comprising:
a plurality of shared queues representative of a common shared queue, said plurality of shared queues being coupled to a plurality of processors; and
means for accessing, by a distributed application executing across the plurality of processors, the plurality of shared queues to process data used by the distributed application.

39. A system of managing common shared queues of a communications environment, said system comprising:
a plurality of shared queues representative of a common shared queue, said plurality of shared queues being coupled to a plurality of processors; and
at least one processor adapted to move one or more messages from one shared queue of the plurality of shared queues to one or more other shared queues of the plurality of shared queues, in response to a detected condition.

40. A system of managing common shared queues of a communications environment, said system comprising:
a plurality of shared queues representative of a common shared queue, each shared queue of said plurality of shared queues being local to a processor of the communications environment;
at least one processor of the communications environment adapted to monitor queue depth of one or more shared queues of the plurality of shared queues;
at least one processor adapted to determine that the queue depth of a shared queue of the one or more shared queues is at a defined level; and
at least one processor adapted to move one or more messages from the shared queue to one or more other shared queues of the plurality of shared queues, in response to the determining.

41. A system of providing a common shared queue, said system comprising:
a plurality of shared queues representative of a common shared queue, said plurality of shared queues being coupled to a plurality of processors; and
a distributed application executing across the plurality of processors accessing the plurality of shared queues to process data used by the distributed application.

42. At least one program storage device readable by a machine tangibly embodying at least one program of instructions executable by the machine to perform a method of managing common shared queues of a communications environment, said method comprising:
providing a plurality of shared queues representative of a common shared queue, said plurality of shared queues being coupled to a plurality of processors; and
moving one or more messages from one shared queue of the plurality of shared queues to one or more other shared queues of the plurality of shared queues, in response to a detected condition.

43. The at least one program storage device of claim 42, wherein said plurality of shared queues reside on one or more external storage media coupled to the plurality of processors.

44. The at least one program storage device of claim 43, wherein said one or more external storage media comprise one or more direct access storage devices.

45. The at least one program storage device of claim 42, wherein each shared queue of said plurality of shared queues is local to a processor of said plurality of processors.

46. The at least one program storage device of claim 42, wherein said detected condition comprises a depth of said one shared queue being at a defined level.

47. The at least one program storage device of claim 42, wherein said moving comprises removing the one or more messages from the one shared queue and placing the one or more messages on the one or more other shared queues based on one or more distribution factors.

48. The at least one program storage device of claim 47, wherein the one or more distribution factors comprise processor power of at least one processor of the plurality of processors.

49. The at least one program storage device of claim 47, wherein the placing comprises determining a number of messages of the one or more messages to be placed on a selected shared queue of the one or more other shared queues.

50. The at least one program storage device of claim 49, wherein the one or more distribution factors comprise local processor power of the processor associated with the selected shared queue and total processor power of at least one processor of the plurality of processors, and wherein the determining comprises using a ratio of local processor power to total processor power in determining the number of messages to be placed on the selected shared queue.

51. The at least one program storage device of claim 50, wherein the determining further comprises adjusting the number of messages to be placed on the selected shared queue, if the number of messages is determined to be unsatisfactory for the selected shared queue.

52. The at least one program storage device of claim 51, wherein the number of messages is determined to be unsatisfactory, when a depth of the selected shared queue would be at a selected level should that number of messages be added.

53. The at least one program storage device of claim 42, wherein said moving is managed by at least one processor of the plurality of processors.

54. The at least one program storage device of claim 53, wherein said at least one processor provides an indication to at least one other processor of the plurality of processors that it is managing a move associated with the one shared queue.

55. At least one program storage device readable by a machine tangibly embodying at least one program of instructions executable by the machine to perform a method of managing common shared queues of a communications environment, said method comprising:
providing a plurality of shared queues representative of a common shared queue, each shared queue of said plurality of shared queues being local to a processor of the communications environment;
monitoring, by at least one processor of the communications environment, queue depth of one or more shared queues of the plurality of shared queues;
determining, via the monitoring, that the queue depth of a shared queue of the one or more shared queues is at a defined level; and
moving one or more messages from the shared queue to one or more other shared queues of the plurality of shared queues, in response to the determining.

56. The at least one program storage device of claim 55, wherein said plurality of shared queues are resident on one or more direct access storage devices accessible to the processors coupled to the plurality of shared queues.

57. The at least one program storage device of claim 55, wherein said moving comprises determining, for each other shared queue of the one or more other shared queues, a number of messages of the one or more messages to be distributed to that other shared queue.

58. The at least one program storage device of claim 57, wherein the determining is based at least in part on processor power of the processor local to the other shared queue.

59. The at least one program storage device of claim 57, wherein the determining comprises adjusting the number, should that number of messages be undesirable for that other shared queue.

60. At least one program storage device readable by a machine tangibly embodying at least one program of instructions executable by the machine to perform a method of providing a common shared queue, said method comprising:
providing a plurality of shared queues representative of a common shared queue, said plurality of shared queues being coupled to a plurality of processors; and
accessing, by a distributed application executing across the plurality of processors, the plurality of shared queues to process data used by the distributed application.
